(19) United States
(12) Patent Application Publication
(10) Pub. No.: US 2006/0132675 A1
(43) Pub. Date: Jun. 22, 2006

(54) Hand-held device having three-dimensional viewing function with tilt sensor and display system using the same

(75) Inventor: Young-Geun Choi, Kyonggi-Do (KR)

Correspondence Address: ST. ONGE STEWARD JOHNSTON & REENS, LLC, 986 BEDFORD STREET, STAMFORD, CT, 06905-5619, US

(73) Assignee: Domotion Ltd., Republic of Korea

(21) Appl. No.: 11/324,103

(22) Filed: Dec. 30, 2005

Related U.S. Application Data
(63) Continuation of application No. PCT/KR03/01821, filed on Sep. 5, 2003.

(30) Foreign Application Priority Data
Jul. 1, 2003 (KR) 10-2003-0044372

(51) Int. Cl. G02F 1/1347; G09G 5/08

(52) U.S. Cl. 349/76; 345/158

(57) ABSTRACT

A hand-held device with 3-dimensional viewing function is disclosed. The hand-held device includes an image viewing circuit. The image viewing circuit has a memory for storing a plurality of image files and image index data mapped to the plurality of image files; a tilt sensor for producing data representing a posture of the hand-held device; a tilt angle conversion module for receiving the posture data from the tilt sensor and thus producing a tilt value of the hand-held device; a viewing position decision module for receiving the tilt value from the tilt angle conversion module, setting a reference tilt value of the hand-held device, producing a relative tilt value of the hand-held device with respect to the reference tilt value thereof and producing an image index data converted from the relative tilt value, and; a controller for sensing the operation of the viewing position decision module and accessing the first memory to search an image index data identical with the image index data produced from the viewing position decision module and an image file mapped to the searched image index data.

### CROSS-REFERENCE TO RELATED APPLICATIONS

The present application is a continuation of pending International patent application PCT/KR2003/001821 filed on Sep. 5, 2003, which designates the United States and claims priority of Korean patent application 10-2003-0044372 filed on Jul. 1, 2003.

### FIELD OF THE INVENTION

The present invention relates to a hand-held device and an image display system using the same, and more particularly to, a hand-held device having three-dimensional viewing function and an image display system using the same.

### BACKGROUND OF THE INVENTION

Recently, computer communication system using an Internet has been considerably progressed and widely spread so that an electronic commerce (e-commerce) transaction or electronic business (e-business) transaction has been created. The e-commerce transaction means a new way to buy, sell and trade goods or services world-widely using information telecommunication technology. More specifically the e-commerce transaction indicates, via a cyber space of computer, an exchange of information on goods or service needed for trading between individuals, between an individual and a company or between a company and a government and payment for the goods or service provided. Generally the e-commerce transaction means that consumers buy goods at a cyber shopping mall in real-time. Such an e-commerce transaction system has some advantages that the customers can be provided with goods or service in more inexpensive price without restriction of time and place and the provider can at all time and easily take information on market and customer. Accordingly, the e-commerce transaction using the Internet has been continuously increased from 1997 and now scale thereof is about twofold. In addition, the e-commerce transaction in the future is expected to widely replace most of the conventional off-line commerce transaction

As various hand-held devices which are small-sized communication device including a hand phone or PDA (personal digital assistants) phone have widely prevailed, the e-commerce transaction is also being carried out by using the hand-held device. However, in general, only a front image of goods arranged in the cyber shopping mall is 2-dimesionally displayed on a screen of the hand-held device. Thus, opportunity for examining goods displayed is limited.

### SUMMARY OF THE INVENTION

An object of the present invention is to provide a hand-held device capable of 3-dimensionally displaying an image of goods or thing arranged in the cyber shopping mall and an image display system using the same.

In a specific aspect of the present invention, a hand-held device comprises an image viewing circuit and a display part. The image viewing circuit has a memory for storing a plurality of image files and image index data mapped to the plurality of image files, wherein the image files and image index data are downloaded from a management server which communicates with the hand-held device and each of the plurality of image files contains an image of goods or thing seen in view of a given position on a sphere, the goods or thing being located at a center of the sphere; a tilt sensor for producing data representing a posture of the hand-held device; a tilt angle conversion module for receiving the posture data from the tilt sensor and thus producing a tilt value of the hand-held device; a viewing position decision module for receiving the tilt value from the tilt angle conversion module, setting a reference tilt value of the hand-held device, producing a relative tilt value of the hand-held device with respect to the reference tilt value thereof and producing the image index data transformed from the relative tilt value, and; a controller for sensing the operation of the viewing position decision module and accessing the first memory to search an image index data identical with the image index data produced from the viewing position decision module and an image file mapped to the identical image index data. The display part displays an image of the image file provided from the first memory via the controller of the image viewing circuit.

Here, the image viewing means further comprises a second memory for storing the tilt value of the hand-held device produced from the tilt angle conversion and the viewing position decision module accesses the second memory to set the reference tilt value, to produce the relative tilt value and to produce the image index data representing a viewing position. The tilt sensor comprises a two-axis acceleration sensor and an A/D converter for converting analogue signal produced from the two-axis acceleration sensor to digital signal, and output of the tilt sensor is proportional to a sine function of the tilt angle of the two-axis acceleration sensor. The tilt angle conversion module produces the tilt value of the hand-held device from an arcsine function of the output of the tilt sensor. In the viewing position decision module, process for producing the image index data is comprised of a step for producing the relative tilt value of the hand-held device with respect to the reference tilt value, a step for comparing the relative tilt value with a given tilt angle previously stored in the viewing position decision module and a step for finding out an index data corresponding to the relative tilt value.

In another specific aspect of the present invention, an image display system comprises a management server in which an image file database is established, wherein the image file database is comprised of a plurality of image files and image index data mapped to the plurality of image files and each of the plurality of image files contains an image of goods or thing seen in view of a given position on a sphere, the goods or thing being located at a center of the sphere; a hand-held device having an image viewing means for carrying out 3-dimensional viewing function in cooperation with the image file database and a display part for displaying an image of a given image file among the plurality of image files according to output of the image viewing means; and a communication network for communication between the management server and the hand-held device with the image viewing means. Wherein, the image viewing means includes a memory for storing the plurality of image files and image index data mapped to the plurality of image files, wherein the image files and image index data are downloaded from the management server; a tilt sensor for producing data representing a posture of the hand-held device; a tilt angle conversion module for receiving the posture data from the tilt sensor and thus producing a tilt value of the hand-held device; a viewing position decision module for receiving the tilt value from the tilt angle conversion module, setting a reference tilt value of the hand-held device, producing a relative tilt value of the hand-held device with respect to the reference tilt value thereof and producing the image index data transformed from the relative tilt value, and; a controller for sensing the operation of the viewing position decision module and accessing the first memory to extract an image index data identical with the image index data produced from the viewing position decision module and an image file mapped to the identical image index data.

### BRIEF DESCRIPTION OF THE DRAWINGS

FIG. 1 is a schematic diagram illustrating a system for 3-dimesnsionally displaying an image of goods or thing using a hand-held device in accordance with the present invention;

FIG. 2a is an illustration for showing a viewing position for obtaining a 3-dimensional image file used in the present invention;

FIG. 2b is an illustration for showing image index data corresponding to 3-dimensional images stored in a database of a management server;

FIG. 3a and FIG. 3b are illustrations for showing images displayed on a screen of the hand-held device according to motion of the hand-held device of the present invention;

FIG. 4 is a schematic block diagram of the hand-held device with 3-dimesnional viewing function according to one embodiment of the present invention; and

FIG. 5 is a flow chart for explaining the operation of a viewing position decision module of the hand-held device according to one embodiment of the present invention.

### DETAILED DESCRIPTION OF THE INVENTION

The embodiments of the present invention will be detail explained with reference to the attached drawings.

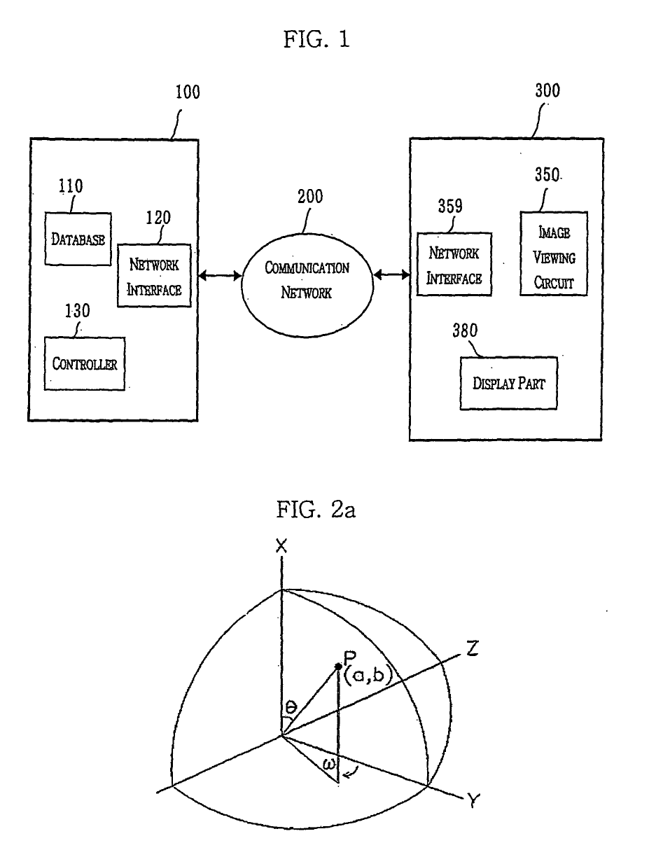

FIG. 1a shows a schematic diagram of a system for 3-dimensionally displaying image of goods or thing using a hand-held device according to the present invention. The system for 3-dimensionally displaying image of goods or thing includes a management server 100 under the control of a manager who manages a cyber shopping mall, the hand-held device 300 having 3-dimensional viewing function and a communication network 200 for communication between the management server 100 and the hand-held device 300.

In the management server 100 there is established database 110 containing information of 3-dimensional image files and image index data of goods or thing. Further, the management server 100 has a network interface 120 and a controller 130. The network interface 120 transmits the 3-dimensional image files and index data in the database 110 via the communication network 20 to the hand-held device 300 and a controller 130 controls the database 110 and the network interface 120.

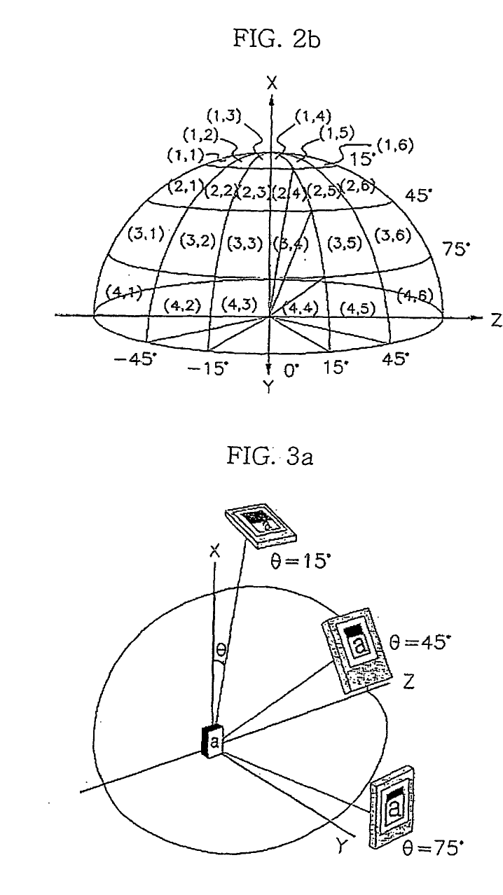

The 3-dimensional image files and image index data in the database 110 may be obtained using a virtual semi-sphere as shown in FIG. 2a. A given viewing-position P on the virtual semi-sphere is defined by (θ, ω) and this is finally transformed into an index data (a, b) representing the image-viewing position as shown in FIG. 2b. Here, “θ” indicates a X-axis tilt angle toward the YZ plane in counterclockwise direction and has a range of 0° through 90°, and “ω” indicates a Y-axis tilt angle on YZ plane vertical to X axis and has a range of −90° to +90° wherein a positive value is appeared in the counterclockwise direction and a negative value is appeared in the clockwise direction.

The goods or the thing positioned at the center of the virtual semi-sphere is taken a picture for 3-dimensional image files. In case of digitized image, data for the 3-dimensional image file can be directly obtained therefrom, while in case of analogue-type image, analogue data is converted via an A/D converter to digital data for the 3-dimensional image file. More detail, the possible range of θ and ω is divided into a plurality of sub-ranges, goods or thing is located at each sub-range divided and then photography is taken, thereby producing a plurality of discrete image files. For example, in order to obtain a front image and a right-side image, a left-side image, a top-side image and a bottom-side image of the goods or thing, the viewing-position P may be located between 0° through 15° of θ, between 15° through 45° of θ, between 45° through 75° of θ or between 75° through 90° of θ. Also, the viewing-position P may be located between 0° through 15° of ω, between 15° through 45° of ω, between 45° through 90° of ω, between −90° through −45° of ω, between −45° through −15° of ω or between −15° through 0° of ω. Therefore, an image captured at (0°˜15°, −90°˜−45°), an image captured at (0°˜15°, −45°˜−15°), an image captured at (0°˜15°, −15°˜0°), an image captured at (0°˜15°, 0°˜15°), an image captured at (0°˜15°, 15°˜45°) and an image captured at (0°˜15°, 45°˜90°) are respectively mapped to index data of (1, 1), (1, 2), (1, 3), (1, 4), (1, 5) and (1, 6) and then stored in the database 110, as shown in FIG. 2b. Also, an image captured at (15°˜45°, −90°˜−45°), an image captured at (15°˜45°, −45°˜−15°), an image captured at (15°˜45°, −15°˜0°), an image captured at (15°˜45°, 0°˜15°), an image captured at (15°˜45°, 15°˜45°) and an image captured at (15°˜45°, 45°˜90°) are respectively mapped to index data of (2, 1), (2, 2), (2, 3), (2, 4), (2, 5) and (2, 6) and then stored in the database 110. In similar, an image captured at (45°˜75°, −90°˜−45°), an image captured at (45°˜75°, −45°˜−15°), an image captured at (45°˜75°, −15°˜0°), an image captured at (45°˜75°, 0°˜15°), an image captured at (45°˜75°, 15°˜45°) and an image captured at (45°˜75°, 45°˜90°) are respectively mapped to index data of (3, 1), (3, 2), (3, 3), (3, 4), (3, 5) and (3, 6) and then stored in the database 110 while an image captured at (75°˜90°, −90°˜−45°), an image captured at (75°˜90°, −45°˜−15°), an image captured at (75°˜90°, −15°˜0°), an image captured at (75°˜90°, 0°˜15°), an image captured at (75°˜90°, 15°˜45°) and an image captured at (75°˜90°, 45°˜90°) are respectively mapped to index data of (4, 1), (4, 2), (4, 3), (4, 4), (4, 5) and (4, 6) and then stored in the database 110.

In the above-mentioned example, the “θ” and the “ω” are respectively divided into four sub-ranges and six sub-ranges. However, the number of divided sub-ranges is not limited thereto and can be variously modified considering the shape of goods or thing to be photographed.

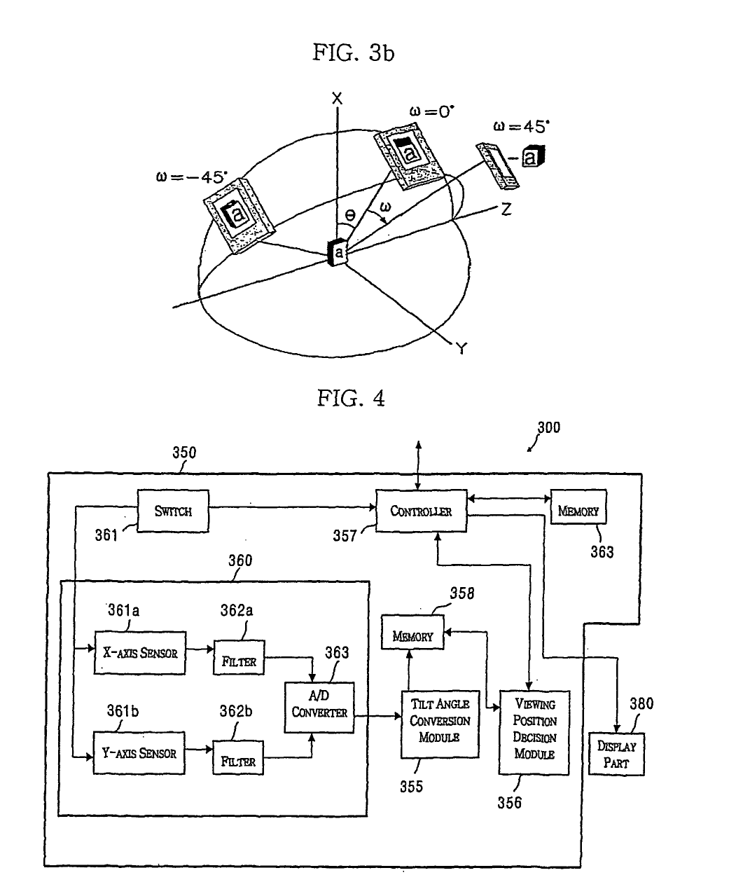

For instance, supposing that the goods or thing has a shape of cube and character “a” is written on one surface of cube of the goods or thing. FIG. 3a illustrates images displayed on a screen of the hand-held device, which are stored in the database 110, wherein the images are photographed at θ=15°, θ=45° and θ=75°. FIG. 3b illustrates images displayed on a screen of the hand-held device, which are stored in the database 110, wherein the images are photographed at ω=0°, ω=45° and ω=−45°.

The hand-held device 300 with 3-dimensional viewing function includes a circuit part 350 for 3-dimensional viewing (hereinafter which is referred to as “image viewing circuit”.) and a display part 380 for displaying images according to the output of the image viewing circuit 350. One example of the image viewing circuit 350 is illustrated in FIG. 4.

In FIG. 4, the image viewing circuit 350 includes a tilt sensor 360 for producing data representing a posture of the hand-held device, an tilt angle conversion module 355 for producing a tilt value of the hand-held device from the posture data thereof and a viewing position decision module 356 for receiving the output of the tilt angle conversion module 355. The viewing position decision module then sets a reference tilt value of the hand-held device, calculates relative tilt value of the hand-held device with respect to the reference tilt value and converts the relative tilt value to the image index data, thereby producing the image index data.

Here, the tilt sensor 360 comprises a two-axis sensor 361a and 361b and an analogue/digital (A/D) converter 363 for converting analogue signal to digital signal. In detail, the tilt sensor 360 includes a X-axis sensor 361a for producing an acceleration value responsive to a X-axis tilt angle of the hand-held device, a Y-axis sensor 361b for producing an acceleration value responsive to a Y-axis tilt angle of the hand-held device, filters 362a and 362b for removing noise from the outputs of the X-axis sensor 361a and the Y-axis sensor 361b and the A/D converter 363 for converting analogue signals of the X-axis sensor 361a and the Y-axis sensor 361b to the digital signals. Wherein the X-axis indicates a length of the cubic goods or thing in FIG. 3a and FIG. 3b and the Y-axis indicates one axis positioned on a plane vertical to the X-axis.

Also, the image viewing circuit 350 further comprises a first memory 358 for storing output of the tilt angle conversion module 355, an operating switch 361 for commanding the tilt sensor 360, a second memory 363 for receiving the image files and image index data from the database 110 of the management server 110 and storing the same and a controller 357 for controlling the operating switch 361. Also, the controller 357 accesses the second memory 363 after receiving the image index data produced from the viewing position decision module 356 to search an image index data identical with the image index data received. Thereafter, the controller 357 produces the image file mapped to the searched image index data and transmits the read image file to the display part 380, thereby displaying on the display part 380 the 3-dimensional image of goods or thing according to the posture variation of the hand-held device 300. Also, in the hand-held device 300 there is provided a network interface 359 for communicating with the management server 100 and for receiving the image file and image index data and a viewer program for the image data (see FIG. 1).

The image viewing circuit 350 of the hand-held device 300 in FIG. 4 receives all 3-dimensional image files in the database 110 of the management server 100. However, the present invention is not limited thereto and the image viewing circuit 350 may be configured to request some of the image files and in turn to receive part of images files stored in the database 110.

The operation of the hand-held device is will be explained. Upon the operation of the switch 361 of the hand-held device 300, the X-axis sensor 361a and the Y-axis sensor 361b of the image viewing circuit 350 produce acceleration values representing the initial posture of the hand-held device. The outputted acceleration value is proportional to a sine function of θ and ω indicating the slope of the X-axis sensor 361a and the Y-axis sensor 361b. The outputs of the X-axis sensor 361a and Y-axis sensor 361b are inputted to the filters 362a and 362b so that the noise is removed. Thereafter, the outputs of X-axis sensor 361 a and the Y-axis sensor 361b are digitally converted via the A/D converter 363, which are inputted to the tilt angle conversion module 355. In the tilt angle conversion module 355 there is extracted the slope of the hand-held device from the digital output of the A/D converter 363. More specifically, the value of θ and ω indicating the slope of the X-axis sensor 361a and the Y-axis sensor 361b can be obtained from the arcsine function of outputs of the X-axis sensor 361a and the Y-axis sensor 361b.

The tilt value of the hand-held device produced from the tilt angle conversion module 355 is stored in the first memory 358 in the form of (θ, ω). Here, the tilt value stored just after the operation of the switch 361 is set as a reference tilt value (θ_{REF}, ω_{REF}). Thereafter when the user modifies posture of the hand-held device by changing an orientation and/or position thereof, that is the tilt angle thereof, the X-axis sensor 361a and the Y-axis sensor 361b produce the acceleration values indicating the change of posture of the hand-held device, and the outputs of the X-axis sensor 361a and the Y-axis sensor 361b are digitally converted at the A/D converter 353 and then are transformed to the tilt value (θ, ω) of the hand-held device. Then the tilt value (θ, ω) is stored in the first memory 358.

The controller 357 checks whether at least two tilt values of the hand-held device are stored in the first memory 358 after the operation of the switch 361, and if so, drives the viewing position decision module 356. The viewing position decision module 356 reads the tilt value stored in the first memory 358, extracts the relative tilt of the hand-held device with respect to the reference tilt value and produces image index data corresponding to the relative tilt.

The controller 357 also senses the operation of the switch 361 and is linked to the management server 100 via the network interface 359 and the communication network 200. Therefore, the image index data and the image files stored in the database 110 of the management server 100 are transmitted to the hand-held device 300 and then stored in the second memory 363 of the hand-held device 300.

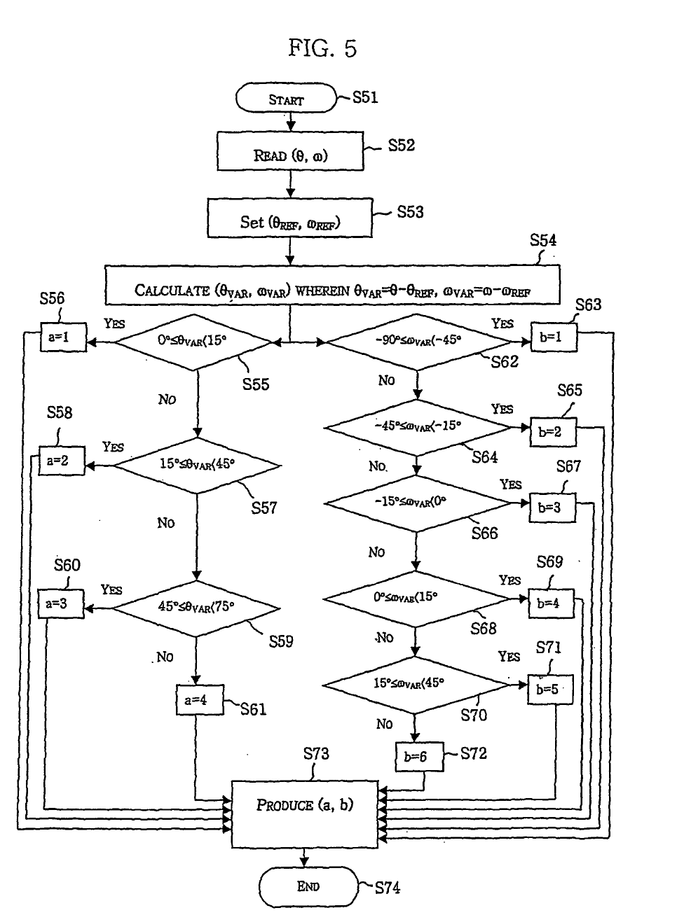

The operation of the viewing position decision module 356 will be detail explained with reference to the FIG. 5. If the command for operating the viewing position decision module 356 is received from the controller 357 at step S51, the viewing position decision module 356 accesses the first memory 358 and reads two tilt values (θ, ω) successively stored in the first memory 358 at step S52. Thereafter, the viewing position decision module 356 sets the first-stored tilt value as the reference tilt value (θ_{REF}, ω_{REF}) at step S53 and then calculates the relative tilt value (θ_{VAR}, ω_{VAR}) based on the second-stored tilt value with respect to the reference tilt value at step S54.

Hereinafter, the process for obtaining the image index data (a, b) from the relative tilt value will be explained. If the relative tilt value of θ_{VAR} is 0° and more and less than 15° (0°≦θ_{VAR}<15°), “a” is designated for the index data “1” at steps S55 and S56 and if the relative tilt value of θ_{VAR} is 15° and more and less than 45° (15°≦θ_{VAR}<45°), “a” is designated for the index data “2” at steps S57 and S58. Also, the relative tilt value of θ_{VAR} is 45° and more and less than 75° (45°≦θ_{VAR}<75°), “a” is designated for the index data “3” at steps S59 and S60 and if the relative tilt value of θ_{VAR} is 75° and more (75°≦θ_{VAR}), “a” is designated for the index data “4” at step S61. In similar, If the relative tilt value of ω_{VAR} is −90° and more and less than −45° (−90°≦ω_{VAR}<−45°), “b” is designated for the index data “1” at steps S62 and S63 and If the relative tilt value of ω_{VAR} is −45° and more and less than −15° (−45°≦ω_{VAR}<−15°), “b” is designated for the index data “2” at steps S64 and S65. If the relative tilt value of ω_{VAR} is −15° and more and less than −0° (−15°≦ω_{VAR}<0°), “b” is designated for the index data “3” at steps S66 and S67 and If the relative tilt value of ω_{VAR} is 0° and more and less than 15° (0°≦ω_{VAR}<15°), “b” is designated for the index data “4” at steps S68 and S69. If the relative tilt value of ω_{VAR} is 15° and more and less than 45° (15°≦ω_{VAR}<45°), “b” is designated for the index data “5” at steps S70 and S71 and If the relative tilt value of ω_{VAR} is 45° and more (45°<ω_{VAR}), “b” is designated for the index data “6” at step S72.

Then the controller 357 after receiving the image index data produced from the viewing position decision module 356, accesses the second memory 363, searches the image index data identical with the received one and then produces the image file mapped to the image index data searched and then display image of the produced image file on the display part 380. For example, if the reference tilt (θ_{REF}, ω_{REF}) is (15°, 0°) and a given tilt value of the hand-held device produced after setting the reference tilt value (θ_{REF}, ω_{REF}) is (50°, 10°), the relative tilt value (θ_{VAR}, ω_{VAR}) is (35°, 10°) which is transformed to the image index data (2,4). The controller 357 reads the produced image index data (2,4) and accesses the second memory 363 to search image index data identical with image index data of (2,4) and then produce the image file stored in the second memory 363 mapped to the searched image index data (2,4). Then image of the searched image file is retrieved on the screen of the display part 380. That is, on the screen of the display part 380 there is displayed an image of goods or thing seen in view of the position corresponding to the slope of the hand-held device, that is the image index data (2,4). Accordingly, user or consumer can search goods or thing during the e-commerce transaction with the hand-held device of the present invention, in a similar manner like an off-line sopping mall.

In the present embodiment, the controller 357 commands the operation of the viewing position decision module 356 after checking whether the tilt value is stored in the second memory 363. However the present invention is not limited thereto. Also, the first memory 358 may be prepared in the viewing position decision module 356. In this case, the viewing position decision module 356 accesses the internal memory (second memory) and searches the initial reference tilt value and the successive tilt value, thereby producing the index data representing a viewing position.

As described above, the left-side image, the right-side image, the top-side image or the bottom-side image of the goods or thing in the off-line can be displayed on the displaying part by tilting the hand-held device in the left-side, the right-side, the top-side or the bottom-side, respectively. Therefore, when carrying out the e-commerce transaction using the hand-held device of the present invention, the consumer or user can more freely and completely search the goods and select more favorable and suitable goods or thing.

Also, the present invention is not limited to the e-commerce transaction and can be applied to any systems for 3-dimensionally displaying a given image by using the hand-held device of the present invention.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A hand-held device comprising:
an image viewing means having a memory for storing a plurality of image files and image index data mapped to the plurality of image files, wherein said image files and image index data are downloaded from a management server which communicates with said hand-held device and each of said plurality of image files contains an image of goods or thing seen in view of a given position on a sphere, the goods or thing being assumed to be located at a center of the sphere;
a tilt sensor for producing data representing a posture of said hand-held device;
a tilt angle conversion module for receiving said posture data from said tilt sensor and thus producing a tilt value of said hand-held device;
a viewing position decision module for receiving said tilt value from said tilt angle conversion module, setting a reference tilt value of said hand-held device, producing a relative tilt value of said hand-held device with respect to said reference tilt value thereof and producing an image index data transformed from said relative tilt value;
a controller for sensing the operation of said viewing position decision module and accessing said first memory to search an image index data identical with the image index data produced from said viewing position decision module and an image file mapped to said searched image index data; and
a display part for displaying an image of said image file provided from said first memory via said controller of said image viewing means.

2. The hand-held device of claim 1, wherein said image viewing means further comprises a second memory for storing said tilt value of said hand-held device produced from said tilt angle conversion and said viewing position decision module accesses said second memory to set said reference tilt value, to produce said relative tilt value and to produce said image index data representing a viewing position.

3. The hand-held device of claim 1, wherein said tilt sensor comprises a two-axis acceleration sensor and an A/D converter for converting analogue signal produced from said two-axis acceleration sensor to digital signal, and output of said tilt sensor is proportional to a sine function of the tilt angle of said two-axis acceleration sensor.

4. The hand-held device of claim 3, wherein said tilt angle conversion module produces said tilt value of said hand-held device from an arcsine function of the output of said tilt sensor.

5. The hand-held device of claim 3, wherein in said viewing position decision module, process for producing said image index data is comprised of a step for producing said relative tilt value of said hand-held device with respect to said reference tilt value, a step for comparing said relative tilt value with a given tilt angle previously stored in said viewing position decision module and a step for finding out an index data corresponding to said relative tilt value.

6. An image display system comprising:
a management server in which an image file database is established, wherein said image file database is comprised of a plurality of image files and image index data mapped to the plurality of image files and each of said plurality of image files contains an image of goods or thing seen in view of a given position on a sphere, the goods or thing being located at a center of the sphere;
a hand-held device having an image viewing means for carrying out 3-dimensional viewing function in cooperation with said image file database and a display part for displaying an image of a given image file among said plurality of image files according to output of said image viewing means; and
a communication network for communication between said management server and said hand-held device with said image viewing means, wherein said image viewing means includes a memory for storing said plurality of image files and image index data mapped to the plurality of image files, wherein said image files and image index data are downloaded from said management server;
a tilt sensor for producing data representing a posture of said hand-held device;
a tilt angle conversion module for receiving said posture data from said tilt sensor and thus producing a tilt value of said hand-held device;
a viewing position decision module for receiving said tilt value from said tilt angle conversion module, setting a reference tilt value of said hand-held device, producing a relative tilt value of said hand-held device with respect to said reference tilt value thereof and producing said image index data transformed from said relative tilt value, and;
a controller for sensing the operation of said viewing position decision module and accessing said first memory to extract an image index data identical with the image index data produced from said viewing position decision module and an image file mapped to said identical image index data.
